(19) United States
(12) Patent Application Publication
(10) Pub. No.: US 2010/0017292 A1
(43) Pub. Date: Jan. 21, 2010

(54) NEED-DRIVEN ADVERTISING

(75) Inventor: EWA DOMINOWSKA, KIRKLAND, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/175,999

(22) Filed: Jul. 18, 2008

(51) Int. Cl. G06Q 30/00

(52) U.S. Cl. 705/14.55

(57) ABSTRACT

An advertising system is provided that interacts with end-users and advertisers to facilitate the generation and delivery of advertisements that are specifically targeted to end-users' product interests and needs. An end-user interacts with the advertising system to provide a product request representing the end-user's interest in receiving advertisements from advertisers. The product request includes a specific product or product category with which the end-user is interested, as well as product attributes further defining the end-user's interests for the specific product or product category. Advertisements are generated and provided to the end-user based on the product request.

### BACKGROUND

Advertising is an established way for merchants to reach an audience of potential customers. Ideally, merchants desire to have their advertisements directed to individuals that are likely to purchase the merchants' products and services. Accordingly, advertising has gone through an evolution of targeting approaches. Initially, advertising was often generally untargeted. However, over time, merchants began to target potential customers in a number of ways. For instance, merchants often target a particular audience by selectively choosing the medium (e.g., newspapers, magazines, radio, television, etc.) in which to advertise. Additionally, advertising is often targeted by selecting the particular context (e.g., specific shows on television, specific web pages on the Internet, etc.) within which the advertisements will appear. Search advertising, in which advertisements are presented in conjunction with search results in response to user search queries, is a more recent form of advertising. Search advertising is often considered to be a targeted form of advertising because the advertisements are directed to the specific user search queries. However, search advertising stills fall short of providing sufficiently targeted and successful advertising. In particular, the majority of searches are done for the purpose of finding information or a web site and not in order to purchase a product (so advertisements are still displayed in a passive mode). Additionally, search advertisements are typically very brief and don't contain enough information to directly result in a product purchase.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to an advertising system that employs a pull model instead of a push model for delivering advertisements to end-users. In accordance with embodiments of the present invention, an end-user interacts with an advertising system to specify product interests and desires. A product request is generated that indicates a specific product or product category with which the end-user is interested and attributes that further define the user's interest. Advertisements from advertisers are generated in response to a product request. The advertisements are generated based on the details of the product request such that the advertisements are specifically targeted to the end-user's product interests and desires.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram is an exemplary system in which embodiments of the present invention may be employed;

FIG. 3 is a block diagram of an exemplary advertising system in accordance with an embodiment of the present invention;

FIG. 4 is a flow diagram showing a method for enabling an end-user to enter a product request in accordance with an embodiment of the present invention;

FIG. 5 is a flow diagram showing a method for enabling an advertiser to interact with an advertising system in a manual mode in accordance with an embodiment of the present invention;

FIG. 6 is a flow diagram showing a method for enabling an advertiser to interact with an advertising system in a semi-automatic mode in accordance with an embodiment of the present invention;

FIG. 7 is a flow diagram showing a method for enabling an advertiser to interact with an advertising system in an automatic mode in accordance with an embodiment of the present invention;

FIG. 8 is a diagram illustrating a specific product request schema in accordance with an embodiment of the present invention; and

FIG. 9 is a diagram illustrating a product category request schema in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide an advertising system that generates and delivers advertisements to end-users that are specifically targeted to end-user's product interests and needs. The advertising system allows end-users to provide product requests that represent end-users' desire to receive advertisements for specific products and/or product categories. A product request from an end-user includes either a specific product or a product category for which the end-user would like to receive advertisements. Additionally, the product request may include product attribute values specified by the end-user that further defines the end-user's product interest. For instance, the end-user may indicate a maximum price the end-user would be willing to pay for a product.

The advertising system allows advertisers to interact with the system to facilitate the generation of advertisements for responses to product requests in three modes: a manual mode, a semi-automatic mode, and an automatic mode. In the manual mode, advertisers manually review and select product requests for responding with advertisements. In the semi-automatic mode, advertisers specify specific products and/or product categories. Advertisements may be generated and provided based on product requests matching advertisers' selected specific products and/or product categories. In the automatic mode, advertisers upload product inventory information, and product requests are automatically matched to product inventor information to generate advertisements in response to the product requests.

Although the term “product” is used throughout the detailed description, one skilled in the art will recognize that embodiments of the present invention equally apply to services. As such, the term “product” used herein is intended to include services.

Accordingly, in one embodiment, an aspect of the present invention is directed to a computer-implemented method for an advertising system to provide need-driven advertising. The method includes providing a user interface allowing an end-user to enter a product request that indicates an interest from the end-user to receive product advertisement information. The user interface allows the end-user to specify a specific product or select a product category from a predefined hierarchy of product categories. The method also includes receiving the product request from the end-user via the user interface, wherein the product request indicates a specific product or a product category and one or more product request attribute values defining the interest from the end-user. The method further includes storing the product request with other product requests from other users. The method also includes allowing an advertiser to review the product request and the other product requests and manually select one or more of the product request and the other product requests for responding with one or more advertisements. The method further includes receiving a selection of the product request from the advertiser and generating an advertisement based on the specific product or product category and the product request attribute values included in the product request. The method still further includes facilitating delivery of the advertisement to the end-user.

In another aspect, an embodiment of the invention is directed to one or more computer-readable storage media embodying computer-useable instructions for performing a method. The method includes providing a user interface allowing an end-user to enter a product request that indicates an interest from the end-user to receive product advertisement information. The user interface allows the end-user to specify a specific product or select a product category from a predefined hierarchy of product categories. The method also includes receiving the product request from the end-user via the user interface, wherein the product request indicates a specific product or a product category and one or more product request attribute values defining the interest from the end-user. The method further includes storing the product request with other product requests from other users. The method also includes receiving product inventory information from an advertiser and storing the product inventory information. The method further includes matching the product request to at least a portion of the product inventory information and generating an advertisement based on the product request and the product inventory information. The method still further includes facilitating delivery of the advertisement to the end-user.

A further aspect of the invention is directed to a need-driven advertising system embodied on one or more computer-readable storage media. The system includes an end-user interface, an advertiser interface, an advertisement generation component, and an advertisement delivery component. The end-user interface facilitates end-users interacting with the advertising system to provide product requests. Each product request indicates a desire for an end-user to receive an advertisement, wherein each product request specifies a specific product or product category and one or more product attribute values. The advertiser interface facilitates advertisers interacting with the advertising system to respond to product requests with advertisements, wherein the advertiser interface allows advertisers to interact with the advertising system in a manual mode, a semi-automatic mode, and an automatic mode. In the manual mode, the advertiser interface facilitates advertisers manually reviewing and selecting product requests to which the advertisers wish to respond with advertisements. In the semi-automatic mode, the advertiser interface facilitates advertisers manually selecting at least one of a specific product and a product category, and wherein advertisements are generated in response to product requests matching specific products and product categories selected by advertisers. In the automatic mode, the advertiser interface facilitates advertisers providing product inventory information, and wherein advertisements are generated in response to product request matching product inventory information provided by advertisers. The advertisement generation component generates advertisements in response to product requests, wherein each advertisement is generated based on a specific product or product category and one or more product attribute values specified by a given product request. The advertisement delivery component that facilitates delivery of advertisements to end-users.

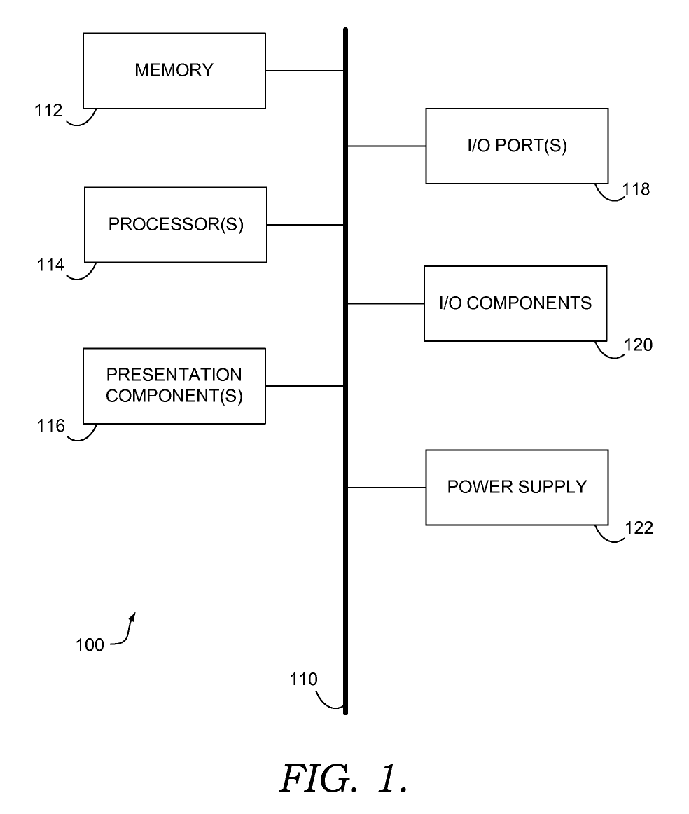

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

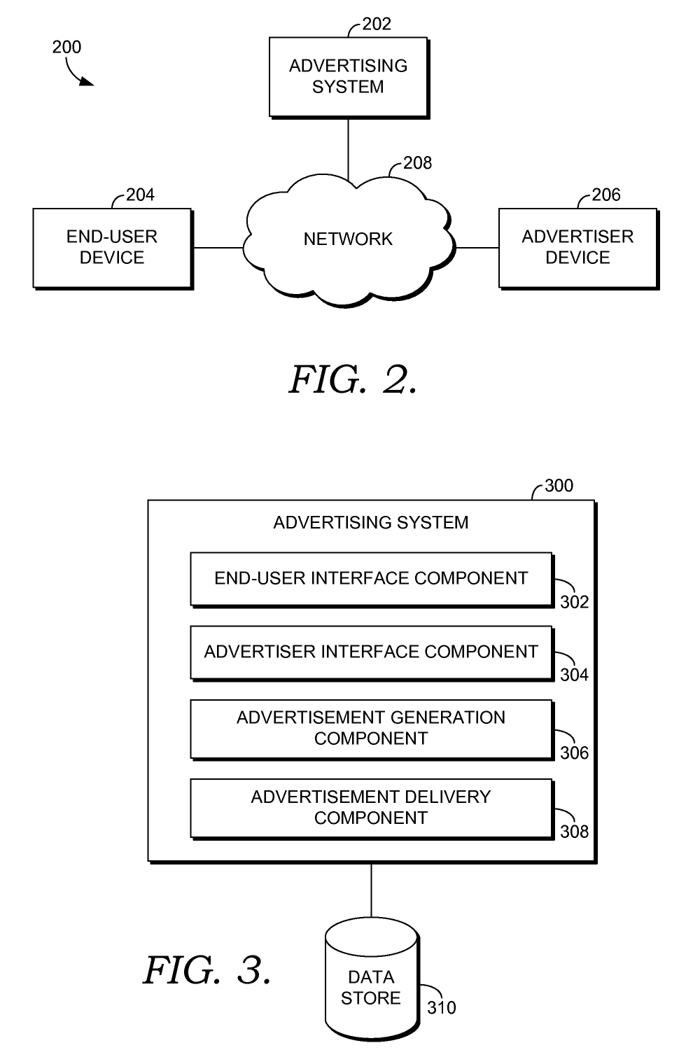

Referring now to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 may include an advertising system 202, an end-user device 204, and an advertiser device 206. Each of the advertising system 202, end-user device 204, and advertiser device 206 may include any type of computing device, such as computing device 100 described with reference to FIG. 1, for example. The components may communicate with each other via a network 208, which may include, without limitation, one or more local area networks (LANs) and/or wide area networks (WANs). Such networking environments are commonplace in offices, enterprise-wide computer networks, intranets, and the Internet. It should be understood that any number of advertising systems, end-user devices, advertising devices, and networks may be employed within the system 200 within the scope of the present invention. Each may comprise a single device or multiple devices in a distribute environment. Additionally, other components not shown may also be included within the system 200.

The system 200 illustrates a need-driven advertising system using a pull model instead of a push model for delivering online advertisements to end-users in accordance with one embodiment of the present invention. Generally, the advertising system 202 provides an interface for end-users and an interface for advertisers to facilitate the delivery of advertisements from advertisers to end-users in a pull mode. More particularly, an end-user may employ an end-user device, such as the end-user device 204, to access the advertising system 202 to place product need or interest requests that specify products and/or product information for which the end-user is interested in receiving advertisements for potential purchases. Advertisers may employ devices, such as the advertiser device 206, to access the advertising system and respond to end-user requests by providing advertisements that meet the end-user's product need/interest request. The advertising system 202 then facilitates delivery of advertisements from advertisers, such as an advertiser associated with the advertiser device 206, to end-users, such as an end-user associated with the end-user device 204.

Referring now to FIG. 3, an exemplary advertising system 300 in accordance with an embodiment of the present invention will be described in further detail. Among other components not shown, the advertising system 300 may include an end-user interface component 302, an advertiser interface component 304, an advertisement generation component 306, an advertisement delivery component 308, and a data store 310. Each component may comprise a program, routine, application, or other machine-executable code capable of performing the actions discussed herein. One skilled in the art will recognize that the components shown in FIG. 3 are provided for illustrative purposes only and other arrangements may be provided in accordance with various embodiments of the present invention.

As noted above, the advertising system 300 may generally facilitate delivery of advertisements from advertisers to end-users using a pull model. The advertising system 300 includes an end-user interface 302 for communicating with end-users. Generally, the end-user interface 302 allows the end-user to access the advertising system 300 using an end-user device, such as the end-user device 204 of FIG. 2, to log into and manage his/her account. For instance, the end-user device 204 may include a web browser that facilitates accessing and communicating with the advertising system 300. The end-user may add new product requests, which may be stored by the advertising system 300 in the data store 310. Additionally, the end-user may view, modify, and/or delete currently active product requests. Further, the end-user may view advertisements that have been provided in response to the end-user's currently active product requests.

Initially, an end-user may be required to sign-up with the advertising service provided by the advertisement system 300. For instance, the end-user may be required to provide information, such as the end-user's name and contact information. Additionally, the end-user may specify preferences for how advertisements should be delivered to the end-user. For instance, the end-user may specify that advertisements be provided to the end-user via email or RSS feeds. One skilled in the art will recognize that a variety of other delivery mechanisms may be employed for delivering advertisements to end-users and the above-indicated delivery mechanisms are only provided as examples. In some embodiments, instead of delivering an advertisement to the end-user via one of these delivery mechanisms, the advertising system 300 may simply deliver a notification that the end-user has an advertisement available, and the end-user may be required to log into the advertising system 300 to access the advertisement. Any and all such variations are contemplated to be within the scope of embodiments of the present invention.

The end-user interface 302 also allows end-users to enter details of product need/interest requests to the advertising system. In particular, the end-user enters information regarding a product or product category for which the end-user is interested in receiving advertisements. The product requests may be stored by the advertising system in the data store 310. In various embodiments of the present invention, the end-user interface 302 allows the end-user to provide two types of product requests: a specific product request; or a product category request.

A specific product request allows the end-user to specify a specific product in which the end-user is interested. For instance, the end-user may specify a particular camera model, such as CANON EOS5D. The specific product request would include the specific product indicated by the end-user, such that advertisers selling that product may respond to the specific product request.

In addition to specifying a specific product, the end-user may also specify other attributes as part of the specific product request. For instance, the end-user may specify an expiration date for the request. The expiration date indicates when the request will expire. When the request expires, the request is removed from the advertising system 300, and the end-user will no longer receive any advertisements for that request. The end-user may also specify a maximum price the end-user would be willing to pay for the specific product. As such, only advertisers that are willing to sell their product at or below that maximum price will respond to the product request.

A product category request allows an end-user to specify a general category of products as opposed to a specific product. This reflects that an end-user may be interested in purchasing a product of a specific type, but does not yet have a specific product in mind. For instance, the end-user may be interested in purchasing a digital camera but has not yet selected a particular camera model to purchase.

To facilitate product category requests, the advertising system 300 maintains a hierarchy of product categories. For example, a product category hierarchy may include: Consumer Electronics→Televisions→Plasma Televisions; or Travel→Beach Vacation→Hawaii→Last Minute. Accordingly, the product category hierarchy will include categories of varying specificity. The end-user can browse the product category hierarchy and select a product category of desired specificity. For example, the end-user could select the “Televisions” category if the end-user is interested in any type of television (e.g., CRT, LCD, plasma, etc.) or the end-user could select the “Plasma Televisions” category if the end-user is only interested in plasma televisions. The level in the hierarchy selected by the end-user will affect which advertisers will respond to the product category request and the advertisements the end-user will receive. A broader category would result in advertisements for a broader range of products, while a narrower category would conversely result in advertisements for a narrower range of products.

In some embodiments, each category has a topical schema associated with it to allow the user to specify attributes for the product category request. The topical schema is particular to each category based on attributes that are relevant to the category. For instance, the attributes associated with a “Plasma Television” category could include: price, size, brand, HD support, etc. As another example, the attributes associated with a “Travel” category could include: price, duration, date, number of travelers, etc. When an end-user selects a particular product category, the end-user interface 302 may present the attributes for the selected product category. The end-user may then choose to enter values for none, some, or all of the attributes. For instance, the advertising system may present the relevant attributes with corresponding text boxes, drop-down boxes, or other user interface widgets that allow the end-user to specify a value for each attribute. Although some of the attributes are category-specific, some of the attributes may be general and shared by many categories. For instance, the end-user may specific a maximum price or the end-user may specify an expiration date for the request, indicating when the request expires. As discussed above, when the request expires, the request is removed from the advertising system 300, and the end-user will no longer receive any advertisements for that request.

In accordance with some embodiments of the present invention, product requests from end-users are formatted into a particular schema that facilitates returning advertisements for the end-user product requests. The schema contains the specific product or product category specified by the end-user, as well as any attributes the end-user has specified for the product request.

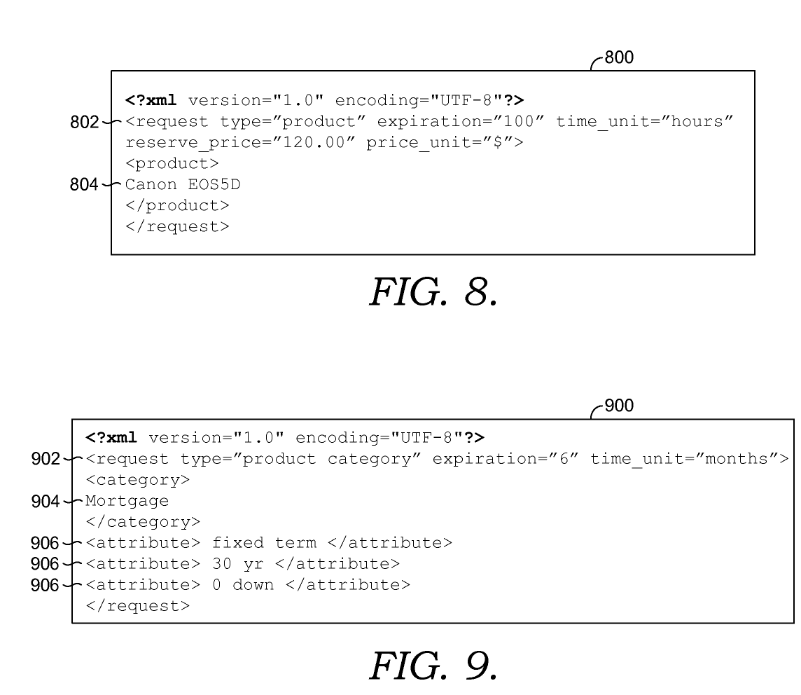

Referring now to FIGS. 8 and 9, diagrams are provided illustrating exemplary product request schemas in accordance with an embodiment of the present invention. FIG. 8 illustrates a specific product request schema 800, while FIG. 9 illustrates a product category request schema 900. As shown in FIG. 8, the specific product request schema 800 specifies the request type 802 as “product.” The specific product request schema 800 also includes a product field 804. In the present example, the product field 804 specifies the product, CANON EOS5D. The specific product request schema 800 also specifies an expiration time (i.e., 100 hours) and a maximum price ($120.00).

As shown in FIG. 9, the product category request schema 900 specifies the request type 902 as “product category.” The product category request schema 900 also specifies an expiration for the request (i.e., 6 months). The product category request schema 900 further includes a category field 904, which indicates the product category as “Mortgage.” A number of attributes 906 from the product category request are also specified in the product category request schema 900.

Returning to FIG. 3, the advertising system 300 includes an advertiser interface component 302 that facilitates advertisers interacting with the advertising system 300 to respond to end-users' product requests with advertisements. In accordance with various embodiments of the present invention, an advertiser may interact with the advertising system 300 in three modes: manual; semi-automatic; and fully automatic. In each of these modes, an advertisement is generated in response to a product request. In particular, the advertising system does not simply match product requests to existing advertisements. Instead, the advertising system generates an advertisement based on the particulars of the product request, including the specific product or product category and any associated attributes specified by the product request. In this way, the advertisement is particularly targeted to the product request.

In the manual mode, an advertiser may browse and/or search end-user product requests stored in the data store 310. As such, the advertiser may locate end-user needs/interests that match products offered by the advertiser. The advertiser may select individual product requests and respond to those product requests with advertisements that are targeted to the end-users' needs and interests specified by the product requests.

In the semi-automatic mode, an advertiser can select particular products and/or product categories that the advertiser would like to respond to product requests. If a user issues a specific product request or a product category request that matches a specific product or product category the advertiser has selected, an advertisement is automatically generated that matches the end-user's needs/interests specified in the product request, and the advertisement is automatically sent to the end-user

In the fully automatic mode, an advertiser can upload information regarding products offered by the advertiser directly to the advertising system 300, which stores the advertiser's product information in the data store 310 or another associated data store. The product information may include an inventory list specifying the products offered by the advertiser. The product information is used to generate automated responses to product requests.

The advertisement generation component 306 facilitates the generation of advertisements for responding to product requests. In accordance with embodiments of the present invention, an advertisement for a given product request is generated in accordance with the particulars of the product request, including the specific product or product category and any associated attributes specified by the product request. As such, the generated advertisement is particularly targeted to the product request.

The advertisement generation component 306 may also employ advertising information provided by advertisers to generate advertisements. In some embodiments, the advertisement generation component 306 may automatically select a portion of advertising information from a collection of advertising information provided by an advertiser based on a particular product request to generate an advertisement. In the fully automatic mode, the advertising information may be selected from the advertiser's product inventory information. In some embodiments of the manual mode, the advertisement generation component 306 may facilitate an advertiser providing an advertisement to the advertising system in response to a product request selected by the advertiser. For instance, an advertiser may select a product request, generate an advertisement based on the product request, and upload the advertisement to the advertising system 300. In some embodiments, the advertising system 300 may convert the advertisement to a common format for the advertising system.

The advertisement delivery component 308 facilitates delivery of advertisements to end-users in response to product requests. In some embodiments of the present invention, the advertisement delivery component 308 delivers the actual advertisement to the end-user. Delivery of the actual advertisement may be accomplished using any known communication method, such as email or RSS feed, for instance. In some embodiments, the end-user may specific communication method preferences, and the advertisement delivery component 308 delivers the advertisement based on the end-user preferences. In other embodiments of the present invention, instead of delivering the actual advertisement, the advertisement delivery component 308 delivers a notification of the availability of the advertisement to the end-user. Similar to the delivery of the actual advertisement, the notification may be delivered using any know communication method and may be performed in accordance with end-user preferences. In embodiments in which notifications are employed, the end-user may access his/her account with the advertising system 300 to view the advertisement.

The advertising system 300 may provide a number of additional functionalities to facilitate the advertising service. For instance, the advertising system 300 may allow for merchant ratings for advertisers. The advertising system 300 may collect implicit and/or explicit merchant ratings. For implicit merchant ratings, each time an end-user interacts with an advertisement from a given advertiser, the information will be logged by the system to create “popular merchants” for each category. Additionally or alternatively, at any time end-users will be able to rate any of the advertisers they have interacted with in the past explicitly. The end-user accounts may store statistics on most commonly used and most highly rated merchants. In some embodiments, end-users are able to share this information with other end-users. In some embodiments, merchant ratings may be used as an attribute for product requests. For instance, an end-user may specify, as part of a product request, that the end-user is interested in advertisements only from advertisers with a minimum merchant rating.

The advertising system 300 may also employ a number of different revenue models in accordance with various embodiments of the present invention. For example, in one embodiment, the advertising system 300 may charge a flat fee to an advertiser for each product request an advertisement response is provided for the advertiser. Additionally or alternatively, a flat fee may be charged each time a user responds to a given advertisement.

In some embodiments, the advertising system 300 may provide conversion tracking to identify when an advertisement results in a product purchase. In such embodiments, the advertising system 300 may employ a revenue share model, in which the advertiser is charged a percentage of revenue from conversions. Any and all such variations are contemplated to be within the scope of embodiments of the present invention.

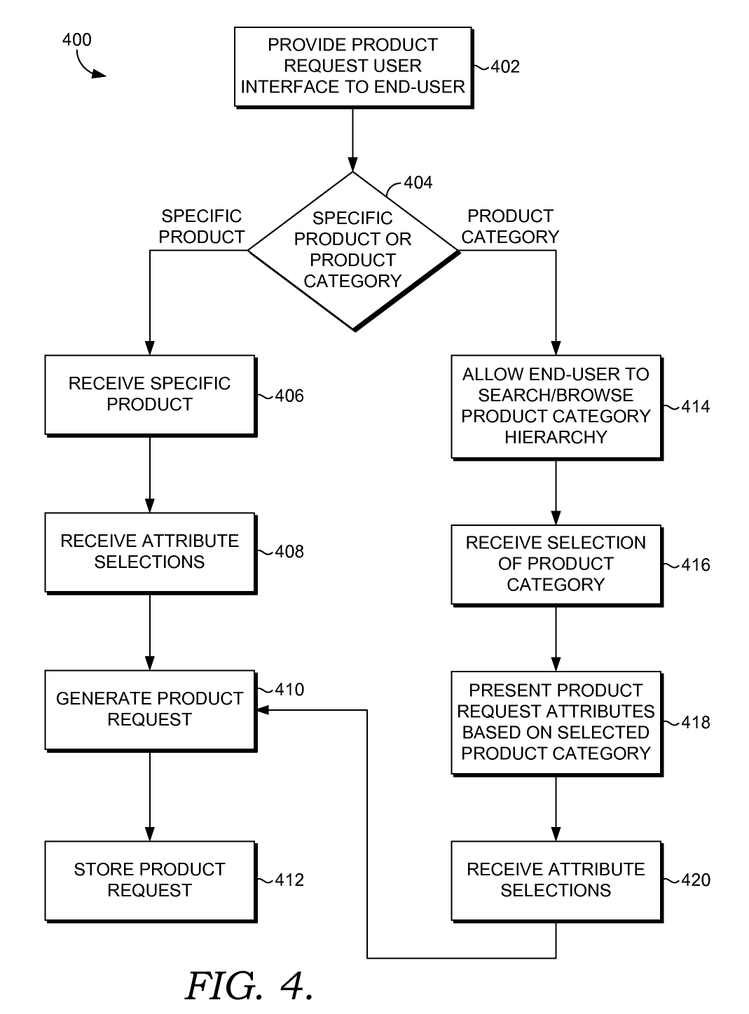

Referring now to FIG. 4, a flow diagram is provided that illustrates a method 400 for allowing an end-user to enter a product request in accordance with an embodiment of the present invention. Initially, as shown at block 402, a product request user interface is provided to the end-user. The product request user interface allows that end-user to interact with the advertising system to enter details of a product request. As shown at block 404, the end-user may employ the product request user interface to specify whether the user wishes to receive advertisements for a specific product or for a product category.

If the end-user wishes to receive advertisements for a specific product, the end-user indicates the specific product at block 406. The end-user may also make one or more attribute selections, as shown at block 408. For instance, as discussed above, the end-user may specify a maximum price the end-user would be willing to pay for the product specified in the product request. Additionally, the end-user may specify an expiration date for the product request after which the end-user does not wish to receive any more advertisements for the specified product. A product request is generated based on the end-user selections, as shown at block 410. The product request includes an indication of the specific product identified by the end-user, as well as any attribute selections also indicated by the end-user. The product request is stored, for instance, in the data store 310 of FIG. 3, as shown at block 412.

Alternatively, if the end-user wishes to receive advertisements for a product category instead of a specific product, the end-user may search and/or browse a category hierarchy provided by the advertising system, as shown at block 414. The end-user selects a particular product category, as shown at block 416. Based on the product category selection, product request attributes that correspond with the selected product category are presented to the end-user at block 418. As discussed above, the advertising system maintains a set of attributes for each product category. The set of attributes for a given product category are specific and relevant to that product category. In some instances, an attribute may be common amongst different product categories. For example, price is an attribute that would apply to most, if not all, product categories. In other instances, an attribute may be relevant for one product category but not another. For example, resolution would be a relevant attribute for digital cameras but would not be relevant to another product category such as travel.

The end-user makes attribute selections, as shown at block 420. In particular, the end-user provides values for attributes presented. For instance, the end-user may specify a particular price or price range or specify a particular brand. The end-user may specify values for none, some, or all of the attributes for the specified product category. A product request is then generated at block 410. The product request includes the product category specified by the end-user, as well as any attribute selections specified by the end-user. The product request is stored, for instance, in the data store 310 of FIG. 3, as shown at block 412.

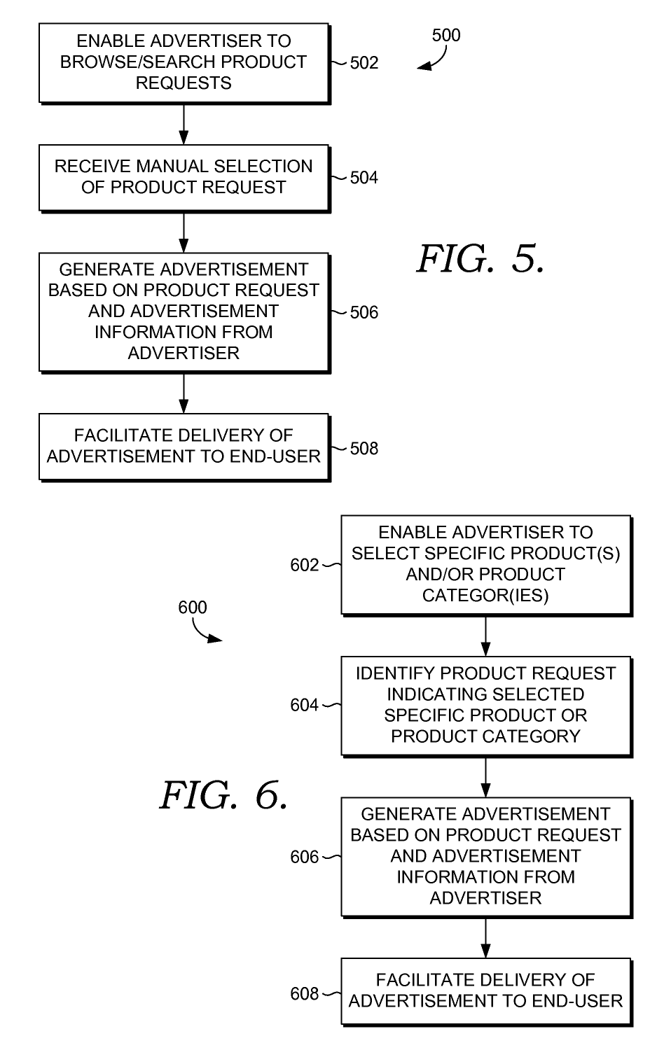

After end-users have specified product requests, the advertising system may generate advertisements for delivery to the end-users. As noted above, the advertising system may allow advertisers to interact with the advertising system in three modes to provide advertisements to end-users, including a manual mode, a semi-automatic mode, and a fully automatic mode. The three approaches will now be discussed with reference to FIGS. 5, 6, and 7.

Turning initially to FIG. 5, a flow diagram is provided that illustrates a method 500 for allowing an advertiser to interact with the advertising system in a manual mode to provide an advertisement to an end-user. As shown at block 502, the advertising system enables an advertiser to browse and/or search product requests. As discussed with reference to FIG. 3, an advertising system, such as the advertising system 300, may store product requests received from end-users in a data store, such as the data store 310. Each product request indicates a specific product or product category and any associated attributes specified by an end-user for the product request. A user interface may be provided by the advertising system that allows the advertiser to browse and/or search those product requests. The advertiser may view the details of each product request include the specific product or category and the associated attributes.

As shown at block 504, the advertiser manually selects a particular product request to which the advertiser would like to provide an advertisement. An advertisement is then generated based on the product request and advertisement information provided by advertiser, as shown at block 506. In some embodiments, the advertiser may provide information that is used by the advertising system to generate the advertisement. In other embodiments, the advertiser may upload a particular advertisement to the advertising system that formats the advertisement in accordance with advertising system requirements.

The advertising system next facilitates delivery of the advertisement to the end-user associated with the product request, as shown at block 508. The advertisement may be delivered to the end-user in a number of different manners within the scope of embodiments of the present invention. For instance, in one embodiment, the advertising system may proactively deliver the advertisement to the end-user using any number of delivery mechanisms, such as email or RSS feed, for example. In some embodiments, the end-user may specify preferred delivery mechanisms. In another embodiment, instead of sending the actual advertisement, the advertising system may send a notification to the end-user indicating that the advertisement is available. The end-user may then be required to access the end-user's account at the advertising system to view the advertisement.

With reference now to FIG. 6, a flow diagram is provided that shows a method 600 for providing an advertisement for a product request in a semi-automatic mode in accordance with an embodiment of the present invention. As shown at block 602, the advertising system enables the advertiser to select one or more specific products and/or one or more product categories. In particular, this allows the advertiser to indicate what types of product requests to which the advertiser would like to respond with advertisements. For specific product selections, the advertising system may maintain a list of specific products that the advertiser may view and select from. Additionally or alternatively, the advertiser may enter a specific product. For product categories, the advertising system maintains a product category hierarchy. The advertiser may browse and/or search the product category hierarchy and select one or more product categories. An advertiser may make specific product and/or product category selections at any time, including before or after product requests are received. The advertising system saves the advertiser's selections. As such, the advertising system may match product requests to specific products and/or product categories selected by the advertiser.

As shown at block 604, the advertising system identifies a product request that includes a specific product or product category matching a specific product or product category selected by the advertiser. Based on the match, an advertisement is generated, as shown at block 606. The advertisement is generated based on the product request (including the specific product or category and specified attributes) and advertisement information from the advertiser. In particular, the advertiser provide a variety of advertisement information to the advertising system. Based on the details of the product request, specific pieces of advertisement information may be selected for generating the advertisement. In this way, an advertisement is generated that is particularly targeted to the product request.

The advertising system next facilitates delivery of the advertisement to the end-user associated with the product request, as shown at block 608. As discussed above, the advertisement may be delivered to the end-user in a number of different manners within the scope of embodiments of the present invention. For instance, in one embodiment, the advertising system may proactively deliver the advertisement to the end-user using any number of delivery mechanisms, such as email or RSS feed, for example. In some embodiments, the end-user may specify preferred delivery mechanisms. In another embodiment, instead of sending the actual advertisement, the advertising system may send a notification to the end-user indicating that the advertisement is available. The end-user may then be required to access the end-user's account at the advertising system to view the advertisement.

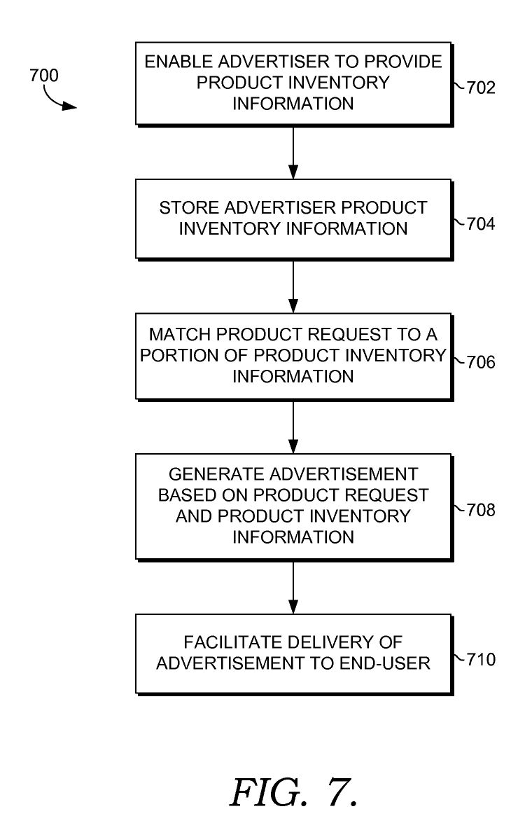

Turning now to FIG. 7, a flow diagram is provided that illustrates a method 700 for providing advertisements for product requests in a fully automatic mode in accordance with an embodiment of the present invention. As shown at block 702, in the fully automatic mode, the advertising system enables the advertiser to provide product inventory information. For instance, the advertiser may upload information regarding some or all of the advertiser's product inventory. The advertiser may provide product inventory information at any time, including before or after product requests are received. The advertising system stores the advertiser's product inventory information in an associated data store, such as the data store 310 of FIG. 3, for instance, as shown at block 704. As such, the advertising system may match product requests to product inventory information provided by the advertiser.

As shown at block 706, the advertising system matches a particular product request to a portion of product inventory information. In particular, the advertising system uses the specific product or product category and associated attributes from the product request to find matching product inventory information. The advertising system then generates an advertisement based on the specifics of the product request and the matching product inventory information, as shown at block 710. As such, the generated advertisement is particularly targeted to the product request.

The advertising system next facilitates delivery of the advertisement to the end-user associated with the product request, as shown at block 712. As discussed above, the advertisement may be delivered to the end-user in a number of different manners within the scope of embodiments of the present invention. For instance, in one embodiment, the advertising system may proactively deliver the advertisement to the end-user using any number of delivery mechanisms, such as email or RSS feed, for example. In some embodiments, the end-user may specify preferred delivery mechanisms. In another embodiment, instead of sending the actual advertisement, the advertising system may send a notification to the end-user indicating that the advertisement is available. The end-user may then be required to access the end-user's account at the advertising system to view the advertisement.

As can be understood, embodiments of the present invention provide an advertising system that provides advertisements that are specifically targeted to end-users product interests and desires. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A computer-implemented method for an advertising system to provide need-driven advertising, the method comprising:
providing a user interface allowing an end-user to enter a product request, the product request indicating an interest from the end-user to receive product advertisement information, wherein the user interface allows the end-user to specify a specific product or select a product category from a predefined hierarchy of product categories;
receiving the product request from the end-user via the user interface, wherein the product request indicates a specific product or a product category and one or more product request attribute values defining the interest from the end-user;
storing the product request with a plurality of other product requests from a plurality of other users;
allowing an advertiser to review the product request and the plurality of other product requests and manually select one or more of the product request and the plurality of other product requests for responding with one or more advertisements;
receiving a selection of the product request from the advertiser;
generating an advertisement based on the specific product or product category and the one or more product request attribute values included in the product request; and
facilitating delivery of the advertisement to the end-user.

2. The method of claim 1, wherein receiving the product request from the end-user via the user interface comprises:
enabling the end-user to browse or search the predefined hierarchy of product categories; and
receiving a selection of a product category from the predefined hierarchy of product categories.

3. The method of claim 2, wherein receiving the product request from the end-user via the user interface further comprises:
presenting a set of product attributes based on the selected product category, wherein each given product category in the predefined hierarchy of product categories includes a separate set of product attributes specific to the given product category; and
receiving attribute values from the end-user for at a portion of the product attributes in the set of product attributes for the selected product category.

4. The method of claim 1, wherein data for the product request including the specific product or product category and the one or more product request attribute values are structured in accordance with a product request schema that facilitates the generation of one or more advertisements to return to the end-user based on the product request.

5. The method of claim 1, wherein allowing the advertiser to review the product request and the plurality of other product requests comprises allowing the advertiser to browse or search the product request and the plurality of other product requests.

6. The method of claim 1, wherein generating the advertisement comprises selecting advertisement information from the advertiser based on the product request and generating the advertisement using the selected advertisement information.

7. The method of claim 1, wherein generating the advertisement comprises receiving an advertisement from the advertiser based on the product request.

8. The method of claim 1, wherein facilitating delivery of the advertisement to the end-user comprises:
sending a notification of the availability of the advertisement to the end-user; and
providing the advertisement to the end-user when the end-user logs into an account with the advertising system.

9. The method of claim 1, wherein facilitating delivery of the advertisement to the end-user comprises:
delivering the advertisement to the end-user without requiring the end-user to log into an account with the advertising system to access the advertisement.

10. One or more computer-readable storage media embodying computer-useable instructions for performing a method comprising:
providing a user interface allowing an end-user to enter a product request, the product request indicating an interest from the end-user to receive product advertisement information, wherein the user interface allows the end-user to specify a specific product or select a product category from a predefined hierarchy of product categories;
receiving the product request from the end-user via the user interface, wherein the product request indicates a specific product or a product category and one or more product request attribute values defining the interest from the end-user;
storing the product request with a plurality of other product requests from a plurality of other users;
receiving product inventory information from an advertiser;
storing the product inventory information;
matching the product request to at least a portion of the product inventory information;
generating an advertisement based on the product request and the at least a portion of the product inventory information; and
facilitating delivery of the advertisement to the end-user.

11. The computer-readable storage media of claim 10, wherein receiving the product request from the end-user via the user interface comprises:
enabling the end-user to browse or search the predefined hierarchy of product categories; and
receiving a selection of a product category from the predefined hierarchy of product categories.

12. The computer-readable storage media of claim 11, wherein receiving the product request from the end-user via the user interface further comprises:
presenting a set of product attributes based on the selected product category, wherein each given product category in the predefined hierarchy of product categories includes a separate set of product attributes specific to the given product category; and
receiving attribute values from the end-user for at a portion of the product attributes in the set of product attributes for the selected product category.

13. The computer-readable storage media of claim 10, wherein data for the product request including the specific product or product category and the one or more product request attribute values are structured in accordance with a product request schema that facilitates the generation of one or more advertisements to return to the end-user based on the product request.

14. The computer-readable storage media of claim 10, wherein facilitating delivery of the advertisement to the end-user comprises:
sending a notification of the availability of the advertisement to the end-user; and
providing the advertisement to the end-user when the end-user logs into an account with the advertising system.

15. The computer-readable storage media of claim 10, wherein facilitating delivery of the advertisement to the end-user comprises:
delivering the advertisement to the end-user without requiring the end-user to log into an account with the advertising system to access the advertisement.

16. A need-driven advertising system embodied on one or more computer-readable storage media, the system comprising:
an end-user interface that facilitates end-users interacting with the advertising system to provide product requests, each product request indicating a desire for an end-user to receive an advertisement, wherein each product request specifies a specific product or product category and one or more product attribute values;
an advertiser interface that facilitates advertisers interacting with the advertising system to respond to product requests with advertisements, wherein the advertiser interface allows advertisers to interact with the advertising system in a manual mode, a semi-automatic mode, and an automatic mode,
wherein in the manual mode, the advertiser interface facilitates advertisers manually reviewing and selecting product requests to which the advertisers wish to respond with advertisements,
wherein in the semi-automatic mode, the advertiser interface facilitates advertisers manually selecting at least one of a specific product and a product category, and wherein advertisements are generated in response to product requests matching specific products and product categories selected by advertisers,
wherein in the automatic mode, the advertiser interface facilitates advertisers providing product inventory information, and wherein advertisements are generated in response to product request matching product inventory information provided by advertisers;
an advertisement generation component that generates advertisements in response to product requests, wherein each advertisement is generated based on a specific product or product category and one or more product attribute values specified by a given product request; and
an advertisement delivery component that facilitates delivery of advertisements to end-users.

17. The need-driven advertising system of claim 16, wherein the end-user interface enables end-users to browse or search a predefined hierarchy of product categories and to select a product category for a product request.

18. The need-driven advertising system of claim 17, wherein each given product category in the predefined hierarchy of product categories includes a separate set of product attributes specific to the given product category.

19. The need-driven advertising system of claim 16, wherein the advertisement delivery component sends a notification of the availability of the advertisement to the end-user; and wherein the advertising system provides the advertisement to the end-user when the end-user logs into an account with the advertising system.

20. The need-driven advertising system of claim 16, wherein the advertisement delivery component delivers the advertisement to the end-user without requiring the end-user to log into an account with the advertising system to access the advertisement.
